(19) United States
(12) Patent Application Publication
(10) Pub. No.: US 2025/0306306 A1
(43) Pub. Date: Oct. 2, 2025

(54) LID DESIGN, MATERIALS AND PROCESS FOR PASSIVE FAU ALIGNMENT IN CO-PACKAGE OPTICS

(71) Applicant: Intel Corporation, Santa Clara, CA (US)

(72) Inventors: Ziyin LIN, Chandler, AZ (US); Peter WILLIAMS, Phoenix, AZ (US); Darren VANCE, Gilbert, AZ (US); Kumar Abhishek SINGH, Phoenix, AZ (US); Joel WRIGHT, Chandler, AZ (US); Sunny SITU, Tempe, AZ (US); Wei LI, Chandler, AZ (US); Yiqun BAI, Chandler, AZ (US)

(21) Appl. No.: 18/616,273

(22) Filed: Mar. 26, 2024

(51) Int. Cl. G02B 6/42

(52) U.S. Cl. CPC G02B 6/4243; G02B 6/4239

(57) ABSTRACT

Various aspects of the present disclosure generally relate to an apparatus and methods for coupling a fiber array unit to an optical die. The apparatus may include an optical die, that may include a plurality of grooves. The apparatus may include a plurality of optical fibers, arranged in the plurality of grooves. The apparatus may include a lid that may include a first surface and a second surface, opposite the first surface, wherein the second surface is non-parallel to the first surface, and an adhesive layer between the optical die and the second surface of the lid.

### STATEMENT OF GOVERNMENT INTEREST

This Invention was made with Government support under Agreement No. N00164-19-9-0001, awarded by NSWC Crane Division. The Government has certain rights in the Invention.

### BACKGROUND

Fiber-based co-packaged optics (CPO) mostly leverage V-grooves on an optical input/output die (optical I/O die) to control the position of fibers, as shown in FIG. 1. To attach the fiber array unit (FAU), there are traditionally two general approaches, i.e., active alignment and passive alignment.

In an active alignment approach, which tends to be a traditional standard, fine-tuning the fiber array unit position may be carried out while actively monitoring the laser signal until a maximum laser power output is reached, which may signal a desirable alignment reached. After such a desirable alignment of the fiber array unit is reached, an adhesive may be dispensed to lock the fibers of the fiber array unit in place. While active alignment may render good fiber alignment and reduce insertion loss, this approach is susceptible to two disadvantages: (1) low throughput as the fine-tuning tends to consume significant time and (2) the requirement of high-quality fiber array unit, especially the uniformity and parallelism of fibers which may have a significant impact on the fiber array unit yield and hence an increase of cost.

On the other hand, traditional passive alignment may involve pressing a lid down on the fibers so as to specifically leverage on the geometrical configurations of grooves to control the fibers' position. While this approach may offer a relatively faster throughput and may be less prone to fiber uniformity/parallelism issues, such passive alignment approach brings new challenges in the adhesive application process. As shown in FIG. 2, when the lid is pressed down on the optical I/O die and the fiber array unit that have adhesive dispensed on the fibers, the adhesive is forced to spread out horizontally, flowing over beyond the fiber tip to cover the waveguide. Covering of the waveguide may cause considerable insertion loss (also arising from unmatched refractive index and waveguide cracks due to high modulus of the adhesive).

Also, in fiber based co-packaged optics, traditional passive alignment of fiber array unit may be desirable due to the relatively faster throughput and better locking of fibers, but this approach continues to face a significant challenge of adhesives flowing into the waveguide, causing not only high insertion loss, but also reliability issues. A reliability test may include high temperatures up to 260° C. solder reflow condition, and cracks at spot size converter (SSC) may occur at such elevated temperatures when a high modulus material, such as an adhesive, is present in the SSC area.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. The dimensions of the various features or elements may be arbitrarily expanded or reduced for clarity. In the following description, various aspects of the present disclosure are described with reference to the following drawings, in which:

FIG. 1 shows an optical I/O die, having V-shaped grooves (top image) and spot size converter with ventholes (denoted SSC <w/ ventholes>), and a fiber array unit (bottom image). The SSC modulates a light mode field diameter between the PIC (which may have a smaller diameter) and the fibers (which may have a bigger diameter) for better light coupling between the two;

FIG. 2 is a schematic diagram showing how an adhesive is traditionally applied under a passive alignment approach, which causes the adhesive to overflow and contact the waveguide;

FIG. 3 shows an apparatus of the present disclosure placed vertically over the adhesive (left image), and how the apparatus may be configured (e.g., angled) to urge against the adhesive (right image);

FIG. 4A is a schematic diagram showing a method of the present disclosure. The top image shows how the first segment of the apparatus may be urged against an adhesive (not shown) that is dispensed on fibers so as to prevent the adhesive overflowing to the waveguide (not shown). The apparatus is angled. The center image shows the apparatus being lifted up away from the fibers and the optical I/O die. Then, the apparatus is configured (e.g., rotated) flat (e.g., parallel to the fibers and optical I/O die). Thereafter, the apparatus is urged against the adhesive (without being angled) so as to have the first segment and the second segment (a portion thereof) urged against the adhesive at the same time (see bottom image). It can be readily understood from the top image that most of the adhesive may be displaced toward the second segment and away from the waveguide, thereby minimizing risk of adhesive overflowing to the waveguide;

FIG. 4B is a photograph showing the adhesive applied using the “angled apparatus” method, which is a method described in various aspects of the present disclosure, demonstrating no overflow of the adhesive to the waveguide;

FIG. 5 shows two examples of the “angled” apparatus configuration described in various aspects of the present disclosure;

FIG. 6 shows an apparatus described in various aspects of the present disclosure, wherein the apparatus may include an opening. The opening may be configured at or proximal to the second segment;

FIG. 7 shows the side view (left image) and perspective view (right image) of an apparatus described in various aspects of the present disclosure, wherein the apparatus has a channel;

FIG. 8 is a photograph showing that the adhesive did not overflow to the waveguide when the apparatus shown in FIG. 7 was used;

FIG. 9 is a schematic diagram showing how the apparatus described in various aspects of the present disclosure is used in a method described in an aspect of the present disclosure;

FIG. 10A is a flow diagram depicting an operation of a method described in an aspect of the present disclosure; and

FIG. 10B is a flow diagram depicting an operation of a method described in an aspect of the present disclosure.

### DETAILED DESCRIPTION

The following detailed description refers to the accompanying drawings that show, by way of illustration, specific details and aspects in which the present disclosure may be practiced. These aspects are described in sufficient detail to enable those skilled in the art to practice the present disclosure. Various aspects are provided for devices, and various aspects are provided for methods. It will be understood that the basic properties of the devices also hold for the methods and vice versa. Other aspects may be utilized and structural, and logical changes may be made without departing from the scope of the present disclosure. The various aspects are not necessarily mutually exclusive, as some aspects may be combined with one or more other aspects to form new aspects.

The present disclosure may attempt to address any of the issues associated with traditional approaches for aligning fibers in fiber-based co-packaged optics (and even in an optical I/O die), such approaches may include traditional active alignment and traditional passive alignment. For brevity, the term “optical I/O die” may be termed “optical die” in the present disclosure.

The present disclosure may attempt to address, for example, any of the issues associated with traditional passive alignment as mentioned above in the background section. For example, in traditional passive alignment approaches, adhesive applied to fibers may be highly susceptible to overflow to the waveguide, which may compromise performance of an optical die. While precise and fine-line dispensing of the adhesive may be considered to address this issue, the required precision and volume control for dispensing an adhesive in such a manner may be likely beyond the capability of existing equipment.

The apparatus and methods of the present disclosure may involve a unique configuration of the apparatus, unique adhesive materials compatible with the apparatus and the methods, and one or more unique process knob (e.g., a process operation or process parameter) in the method. Such unique configuration, adhesive materials, and process knob help to minimize or resolve risks that traditional alignment approaches are susceptible to.

The apparatus of the present disclosure may be a lid having a unique configuration. The lid may be configured such that when the lid is applied against an adhesive, the adhesive gets directed away from the waveguide. The lid may have an empty or additional volume to accommodate any adhesive (e.g., excess adhesive and/or adhesive directed away from the waveguide). The configuration of the apparatus (e.g., the lid) may alter the manner in which an adhesive is traditionally applied on fibers of a fiber array unit. The apparatus (e.g., the lid) may allow use of adhesive materials that change how an adhesive may be traditionally applied on fibers of a fiber array unit, for example, under traditional passive alignment.

Further, there may be an apparatus of the present disclosure, that may include the lid. For example, such an apparatus may include (i) an optical die, including a plurality of grooves, (ii) a plurality of optical fibers, arranged in the plurality of grooves, (iii) the lid, which may include a first surface and a second surface, opposite the first surface, wherein the second surface may be non-parallel to the first surface, and (iv) an adhesive layer between the optical die and the second surface of the lid.

The methods of the present disclosure may involve a process of applying the apparatus (the lid) in a manner that directs the adhesive away from the waveguide. The methods of the present disclosure may allow use of adhesive materials that change how adhesive may be traditionally applied on fibers of a fiber array unit, for example, under traditional passive alignment.

Accordingly, the present disclosure generally relates to an apparatus that may include an optical die, including a plurality of grooves; a plurality of optical fibers, arranged in the plurality of grooves; a lid, including a first surface and a second surface, opposite the first surface, wherein the second surface may be non-parallel to the first surface; and an adhesive layer between the optical die and the second surface of the lid.

The lid may be an apparatus that may include a body, including a first segment and a second segment. The first segment may be configured to urge an adhesive against fibers of a fiber array unit. The fibers may be arranged to correspond in position with grooves of an optical die. The second segment may be configured to accommodate the adhesive displaced by the first segment. The first segment may be configured to prevent the adhesive from contacting a waveguide of the optical die, wherein the waveguide may be proximal to the grooves. The first segment and the second segment may be configurable to have the first segment displace the adhesive toward the second segment and away from the waveguide so as to couple the fiber array unit with the optical die.

Accordingly, the present disclosure also generally relates to an apparatus that may include a body, including a first segment and a second segment. The first segment may be configured to urge an adhesive against fibers of a fiber array unit. The fibers may be arranged to correspond in position with grooves of an optical die. The second segment may be configured to accommodate the adhesive displaced by the first segment. The first segment may be configured to prevent the adhesive from contacting a waveguide of the optical die, wherein the waveguide may be proximal to the grooves. The first segment and the second segment may be configurable to have the first segment displace the adhesive toward the second segment and away from the waveguide so as to couple the fiber array unit with the optical die. The term “urge”, and its grammatical variants, in the context of the present disclosure means to direct one element to another, optionally via a force. For example, urging the adhesive against the fibers means to direct the adhesive toward the fibers, wherein a force may be applied on the adhesive. A force may be applied by pressing the apparatus onto the adhesive or from the weight of the apparatus that is laid on the adhesive. Said differently, the adhesive may be pressed against the fibers. The force may be applied directly or indirectly. Applying a force directly may involve, for example, urging the apparatus against the adhesive to press the apparatus against the adhesive. Applying a force indirectly may involve, for example, another element that may exert a force, which then acts on the apparatus against the adhesive. The term “couple” in the context of the present disclosure means to have two elements optically coupled so as to have an optical signal (e.g., light) transmittable from one of the two elements to the other and/or vice versa. In addition, the term “couple” in the context of the present disclosure may include within its meaning to have the two elements adhered together, e.g., by an adhesive, to be optically coupled.

The present disclosure also generally relates to a method that may include arranging fibers of a fiber array unit to correspond in position with grooves of an optical die, dispensing an adhesive on the fibers, and urging an apparatus as described in various aspects and examples of the present disclosure against the adhesive dispensed on the fibers to displace the adhesive toward the second segment and away from the waveguide so as to couple the fiber array unit with or to the optical die. The apparatus may include a body, including a first segment and a second segment, wherein the first segment may be configured to urge an adhesive against fibers of a fiber array unit, wherein the fibers may be arranged to correspond in position with grooves of an optical die, wherein the second segment may be configured to accommodate the adhesive displaced by the first segment, and wherein the first segment may be configured to prevent the adhesive from contacting a waveguide of the optical die, wherein the waveguide may be proximal to the grooves, and wherein the first segment and the second segment may be configurable to have the first segment displace the adhesive toward the second segment and away from the waveguide so as to couple the fiber array unit with the optical die.

The present disclosure also generally relates to a method that may include arranging fibers of a fiber array unit to correspond in position with grooves of an optical die, dispensing an adhesive on an apparatus as described in various aspects and examples of the present disclosure, configuring the apparatus to have the adhesive dispensed thereon face the fibers, contacting the adhesive dispensed on the apparatus with the fibers, and urging the apparatus against the adhesive to displace the adhesive toward the second segment and away from the waveguide so as to couple the fiber array unit with or to the optical die. The apparatus may include a body, including a first segment and a second segment, wherein the first segment may be configured to urge an adhesive against fibers of a fiber array unit, wherein the fibers may be arranged to correspond in position with grooves of an optical die, wherein the second segment may be configured to accommodate the adhesive displaced by the first segment, and wherein the first segment may be configured to prevent the adhesive from contacting a waveguide of the optical die, wherein the waveguide may be proximal to the grooves, and wherein the first segment and the second segment may be configurable to have the first segment displace the adhesive toward the second segment and away from the waveguide so as to couple the fiber array unit with the optical die.

Advantageously, the apparatus and methods of the present disclosure offer several solution paths that enable the use of adhesive in an alignment approach (e.g., passive alignment) without suffering from insertion loss and reliability issues, and minimise or eliminate adhesive spillage on a waveguide.

Advantageously, the apparatus and methods of the present disclosure are able to considerably reduce the risk of an adhesive overflowing into the waveguide without compromising throughput and without needing any equipment upgrades.

To more readily understand and put into practical effect the present disclosure, particular aspects will now be described by way of examples and not limitations, and with reference to the drawings. For the sake of brevity, duplicate descriptions of features and properties may be omitted.

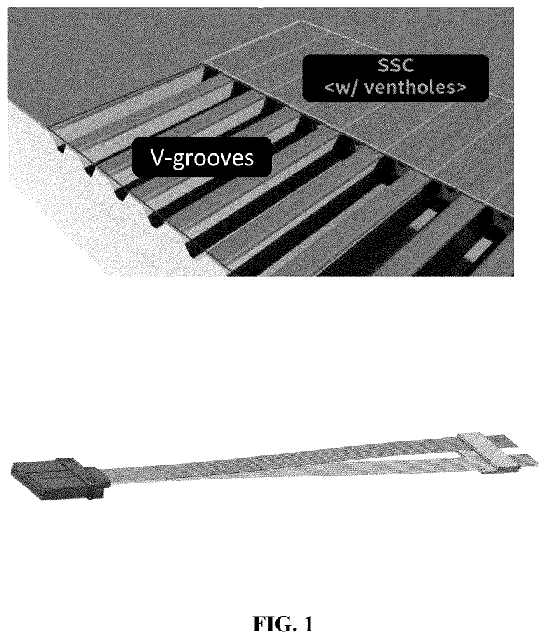

FIG. 1 shows a perspective view of a fiber array unit (bottom image) and an optical die (top image). The optical die may include V-shaped grooves and a spot size converter (SSC) with ventholes, which the V-shaped grooves lead to. The fibers of the fiber array unit may be arranged to correspond in position with (e.g., fit into) the V-shaped grooves (not shown). The waveguide may reside adjacent to the spot size converter (not shown). In the context of the present disclosure, the optical die may be a component capable of integrating multiple photonic functions on a single chip. The optical die may include a waveguide for guiding light (as a non-limiting example of an optical signal) between different parts of a circuit. The optical signal may also be a laser. The optical die may be capable of receiving and delivering data as optical signals (e.g., receiving an optical signal as an input and delivering an optical signal as an output), controlling intensity of phase of the optical signal, capture and convert optical signals into electrical signals, divide or combine optical signals, filter and/or transmit optical signals of one or more specific wavelengths. In the context of the present disclosure, the fiber array unit refers to a component or an assembly that involves an array of optical fibers, such that the fiber array unit may be capable of optical integration where multiple optical fibers may be aligned and connected to an optical die. Alignment of the one or more optical fibers of a fiber array unit may include having the one or more fibers correspond in position with grooves of an optical die, in other words, the term “array” in the context of a fiber array unit disclosed herein refers to the one or more fibers that may be arranged in a manner to suit a purpose or pattern mentioned herein.

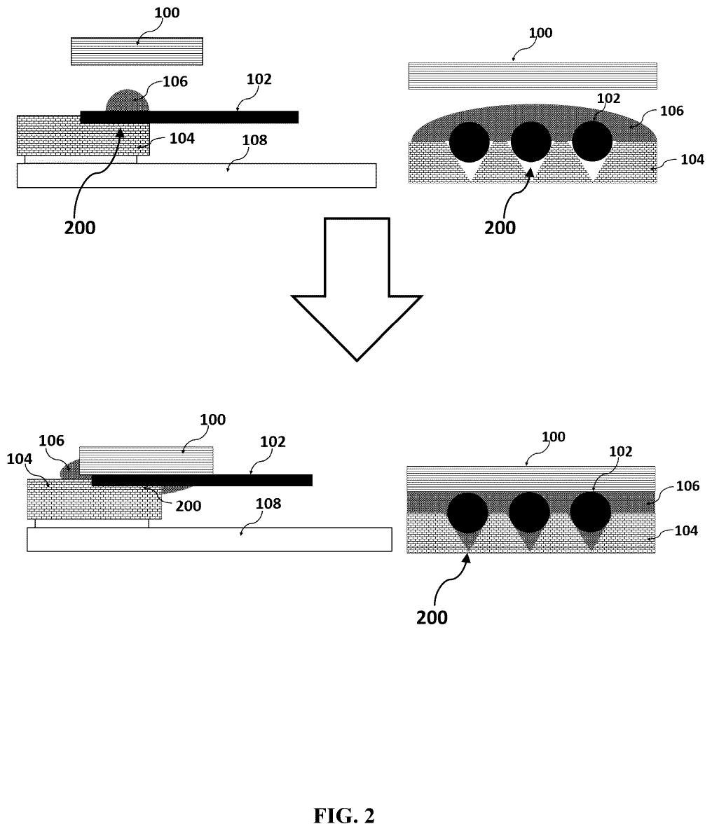

FIG. 2 shows a side view of a traditional passive alignment method. In the top left image of FIG. 2, the apparatus 100 may be placed vertically over the adhesive 106. Observably, the apparatus 100 is configured (e.g., arranged) parallel to the fibers 102 of a fiber array unit and a waveguide of the optical die 104 at the same time. The top right image in FIG. 2 shows another side view of the same arrangement of fibers 102 in the top left image of FIG. 2. Observably, the apparatus 100 may be placed vertically over the adhesive 106. The adhesive 106 may be dispensed on the fibers 102. The fibers 102 may be arranged in position that corresponds to the grooves 200 (e.g., V-shaped grooves in this instance) of the optical die 104. When the apparatus 100 is urged against the adhesive 106 as shown in the bottom left image of FIG. 2, it can be seen that the adhesive 106 overflows to the left of the apparatus 100 and undesirably contacts the waveguide. The bottom right image shows the adhesive fills the grooves 200. While a solution that may be considered is to reduce the amount of adhesive dispensed, changes to a process recipe (operation or parameters in the process) to cater to such a solution may be overly difficult (or not even possible), as a dispenser may often be limited to use of a time-pressure needle. Such time-pressure needle tends to have large diameter needle size(s) (25-gauge or larger). As such, dispensing equipment may have to be upgraded, which requires considerably significant time and resources. That said, the use of smaller diameter needles may compromise throughput as smaller diameter needles require longer dispensing time. The present apparatus and methods of the present disclosure are able to circumvent such limitations. 108 denotes an integrated heat spreader, which may be used for package heat dissipation, i.e., to dissipate heat away from the optical die and other components.

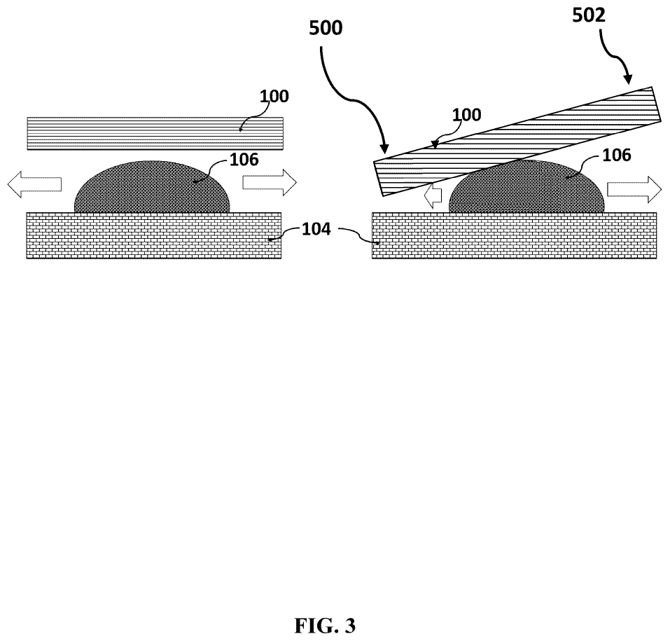

FIG. 3 shows the apparatus 100 in a method described in an aspect of the present disclosure. The method may be referred to as an “angled apparatus” method due to how the apparatus 100 is configured (i.e., angled against the adhesive 106). The left image shows the apparatus 100 vertically placed over the adhesive 106 that is dispensed on the optical die 104. The arrows show that if the apparatus 100 positioned in such a manner is pressed against the adhesive 106, it may be very likely for the adhesive 106 to overflow on both sides. However, if the apparatus 100 is configured and urged against the adhesive 106 at an angle as shown in the right image, the adhesive 106 tends to be displaced to one side as depicted by the arrows, which may help minimize adhesive overflowing to the other side where the waveguide is. 500 and 502 denote the first segment and the second segment of the apparatus 100, respectively.

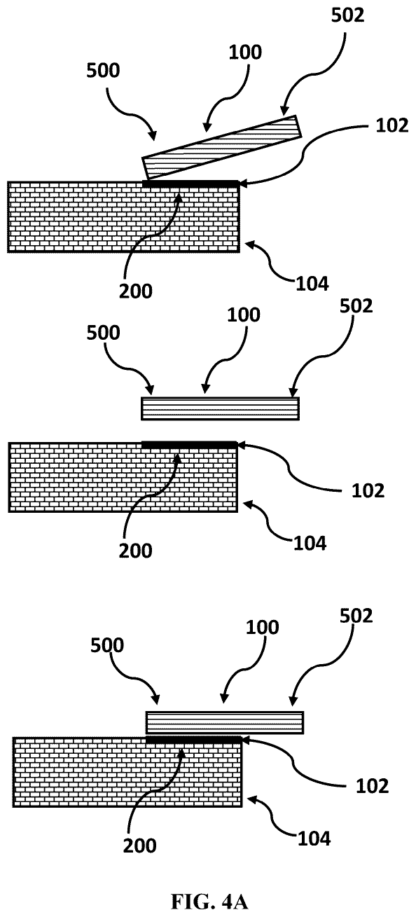

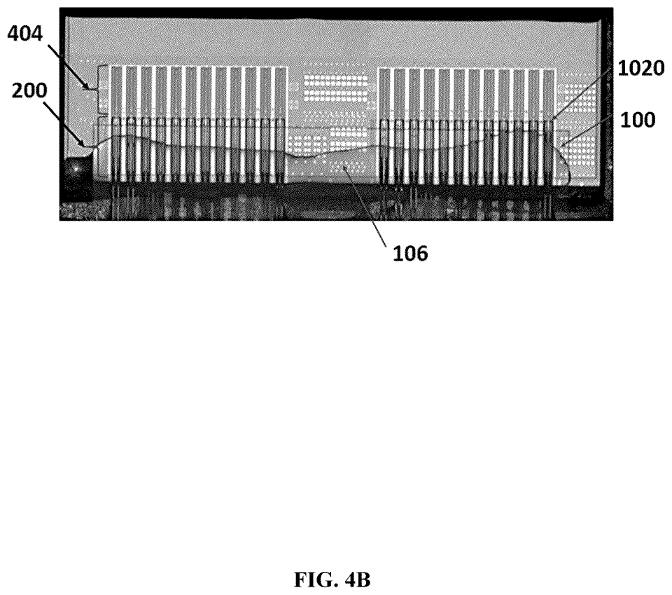

FIG. 4A shows the apparatus 100 in a method described in an aspect of the present disclosure. The method may rely on a process recipe (i.e., operation) that may set out how the apparatus 100 may be configured and/or operated. As shown in the topmost image, the apparatus 100 may be configured at an angle and may be urged against an adhesive (not shown) to prevent the adhesive from overflowing to the waveguide. Observably, the first segment 500 of the apparatus 100 touches down on the fibers 102 positioned in the grooves 200 of the optical die 104. The apparatus 100 may then be lifted up and away from the fibers and the optical die 104 (see center image). The apparatus 100 may then be configured (e.g., rotated flat and parallel to the fibers 102 and the optical die 104). Thereafter, the apparatus 100 may be urged against the adhesive (not shown) in a manner wherein the first segment 500 and the second segment 502 (e.g., a portion thereof) may be urged against the adhesive at the same time (see bottom image).

FIG. 4B shows the result of FIG. 4A, wherein the adhesive 106 is confined within the grooves 200 and did not overflow to contact the waveguide 404. 1020 denotes the tip of the fibers.

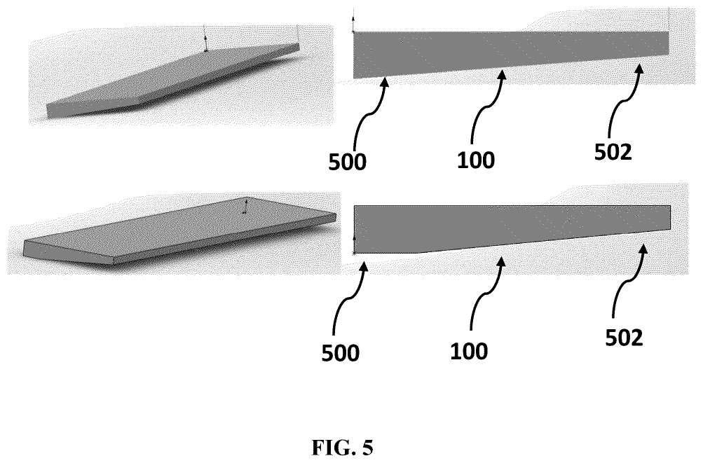

FIG. 5 shows two non-limiting examples of the apparatus described in various aspects of the present disclosure. In the two top images, it can be seen that second segment 502 may be vertically shorter than the first segment 500 such that the planar surface connecting the edge of the first segment 500 to the second segment 502 (e.g., edge of second segment 502) may be an inclined planar surface. From the two bottom images, it may be seen that the first segment 500 includes a planar surface and the second segment 502 may be shorter in height compared to the first segment 500 so as to render an inclined planar surface at the second segment, wherein the planar surface may be configurable to be parallel to the waveguide, and wherein the inclined planar surface connects to the planar surface of the first segment 500. In the context of the present disclosure, the term “planar” may refer to a surface which is flat (e.g., a surface which is entirely flat) or any element having such a surface. In other words, planar elements of the apparatus 100 disclosed herein may be configured such that the apparatus 100 may have one or more surfaces that are flat. In both the top and bottom images, it may be seen that the bottom surface of the apparatus 100 is angled. With such an angled bottom surface, a force may be rendered on the adhesive (i.e., to displace the adhesive toward the second segment 502) when the apparatus 100 is operated vertically (without needing to tilt the apparatus 100), reducing complexity of the apparatus's operation and process recipe.

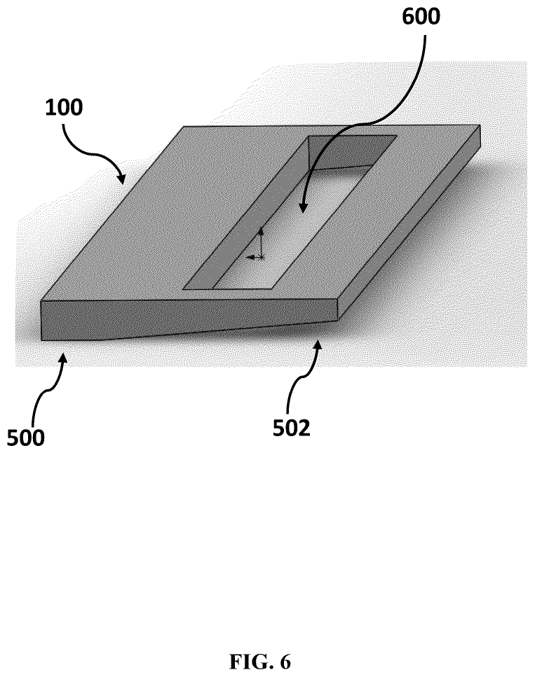

FIG. 6 is an apparatus 100 described in various aspects of the present disclosure, wherein the apparatus 100 may have an opening 600. The opening 600 may be configured proximal to or at the second segment 502 and distal from the first segment 500. The opening 600 may allow for an adhesive to be dispensed through the apparatus 100. The opening 600 may accommodate any adhesive displaced by the first segment 500. The first segment 500 may have a planar surface as shown in FIG. 5 bottom right image. The first segment 500 may be connected to the second segment 502 by an inclined planar surface (as shown in FIG. 5 top right image). The inclined planar surface may be connected to the planar surface of the first segment 500 (as shown in FIG. 5 bottom right image). In summary, an adhesive may be dispensed into the opening 600 and may flow horizontally to glue the optical die and fibers (and even the apparatus 100) together. The bottom of apparatus 100 may be angled to control the relative flow speed of the adhesive in either direction (toward or away from the waveguide).

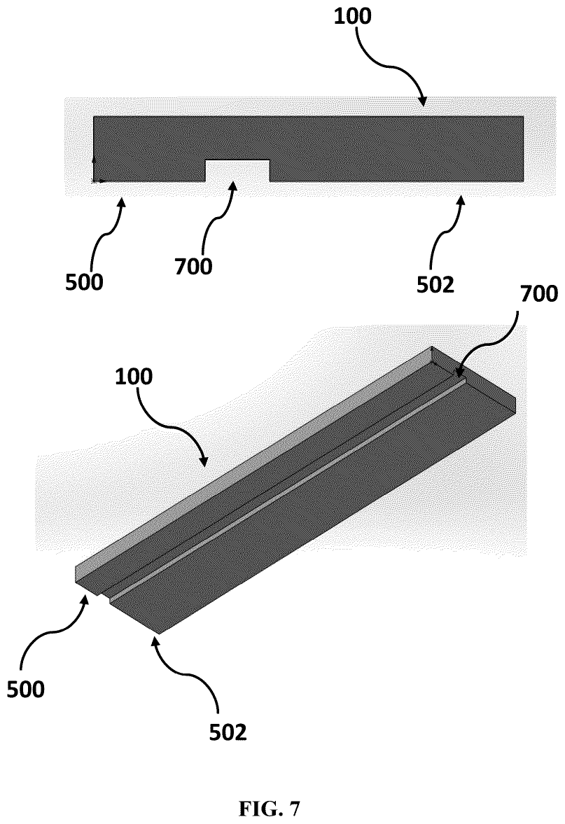

FIG. 7 (both top and bottom images) shows a portion of the second segment 502 proximal to the first segment 500, wherein the portion may include a channel 700 to accommodate the adhesive displaced by the first segment 500. In various aspects and examples of the present disclosure, the term “channel” may be interchangeably referred to as a “trench”. From the bottom image where a perspective view of the apparatus 100 is shown, it can be envisaged that the channel 700 may be configured orthogonal to the grooves and may extend across the apparatus 100 to render an opening at one vertical side of the apparatus and another opening at an opposing vertical side of the apparatus (also see side view in top image of FIG. 7). The channel 700 may be created (e.g., by laser ablation) at the bottom side of the apparatus 100 (the side of apparatus 100 that may be urged against the adhesive) to accommodate any excess adhesive. As apparatus 100 is pressed down, the adhesive may fill the channel 700 first before continue flowing toward (in less amount) and/or away (in more amount) from the waveguide.

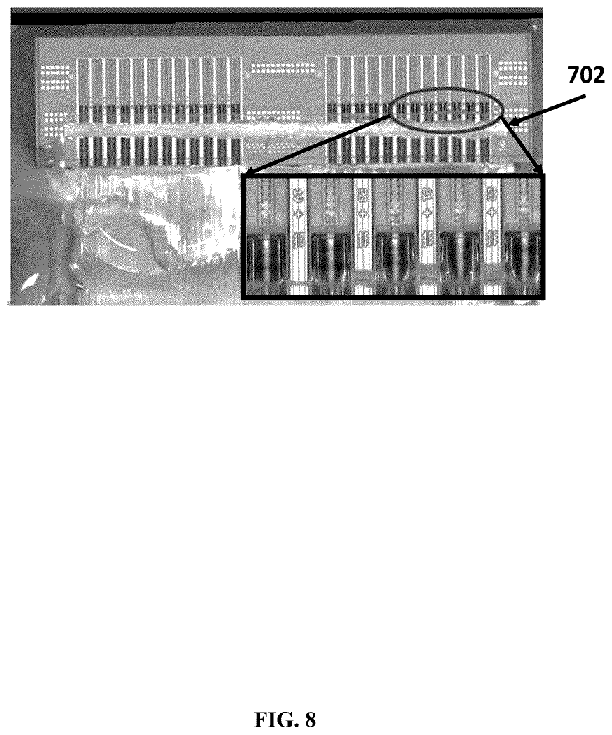

FIG. 8 demonstrates a proof-of-concept with the use of the apparatus shown in FIG. 7 (e.g., channel created by laser ablation). It can be seen there is a single “strip” 702 of adhesive formed due to the channel, and no adhesive overflowed to the waveguide. It was demonstrated that using the apparatus with the channel enables higher pressing force without the adhesive touching the waveguide. The circled area may have more adhesive flow based on FIG. 4B, but in this instance with a channel, it can be seen from the magnified inset image that the adhesive flow becomes more controllable as a pocket created by the channel captured excess volume of the adhesive. The volume of the channel may depend on the adhesive dispensing capability. The channel may be structurally configured to be either narrow and vertically deep, or wide and vertically shallow. The number of channels may be one or more. The configuration may depend on application needs, cost and/or mechanical robustness of the apparatus.

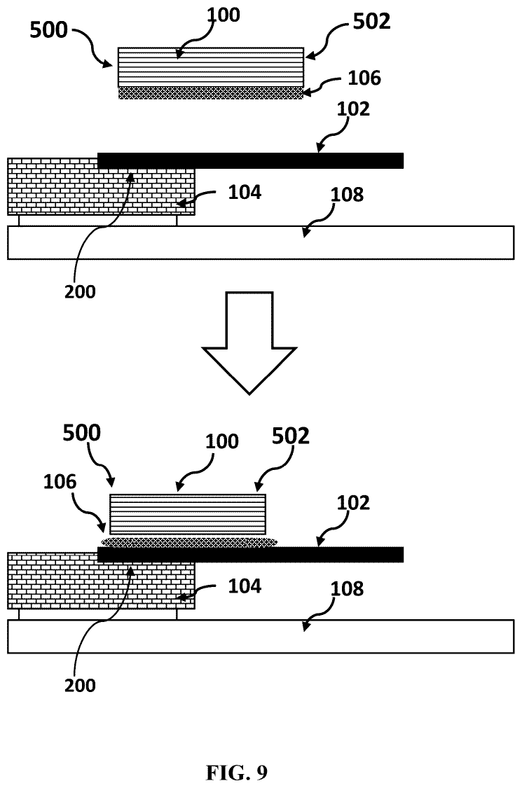

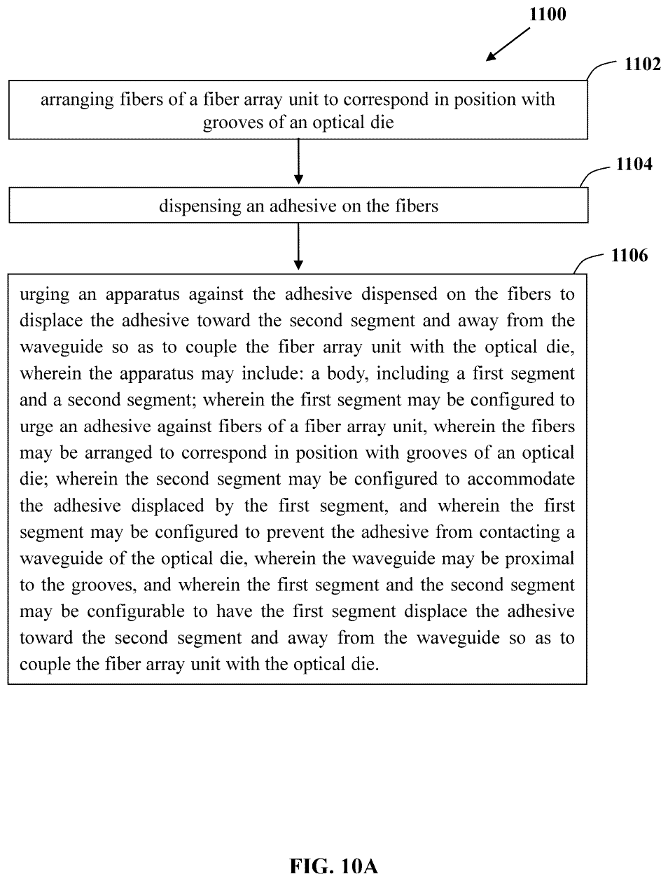

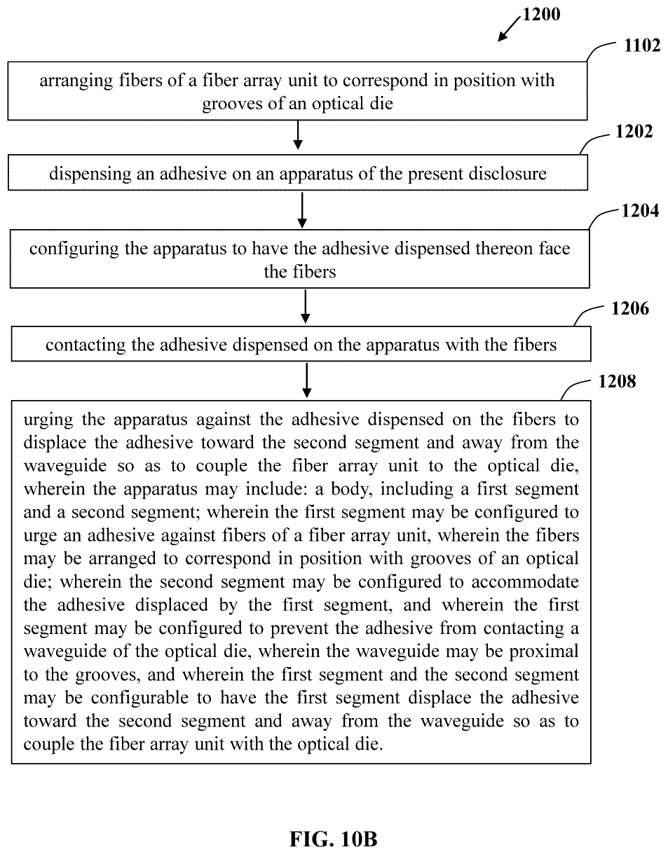

FIG. 9 shows the apparatus 100 in a method described in an aspect of the present disclosure. The method involves a pre-applied adhesive film 106 to the apparatus 100 instead of dispensed liquid adhesives on fibers 102. The advantages of pre-applied adhesive film 106 at least include (1) its thickness may be easily controlled to achieve a defined total adhesive volume, and (2) its viscosity and thixotropic index of the pre-applied adhesive film 106 may be much higher than liquid adhesives and therefore the risk of flowing into a waveguide may be much lower or even eliminated. The materials of such pre-applied adhesive film 106 may be laminated to the apparatus 100 at a panel level and then configured to the form factor required. The materials for such adhesive may be either ultraviolet (UV) cured or thermal cured. The former may be the same as what may be currently available while the latter may leverage on existing thermal compression bonding process/equipment with modified collaterals. The operation of this method may be described in more detail in FIG. 10B.

FIG. 10A is a flow diagram showing a method described in an aspect of the present disclosure. The method has been demonstrated in, for example, FIG. 3 and FIG. 4A. FIG. 10A outlines a method 1100 for assisting with coupling a fiber array unit to an optical die. The method 1100 may involve an operation 1102 of arranging fibers of the fiber array unit to correspond in position with grooves of the optical die, an operation 1104 of dispensing an adhesive on the fibers, and an operation 1106 of urging an apparatus described in various aspects and examples of the present disclosure against the adhesive dispensed on the fibers to displace the adhesive toward the second segment and away from the waveguide so as to couple the fiber array unit with or to the optical die. The apparatus may include: a body, including a first segment and a second segment; wherein the first segment may be configured to urge an adhesive against fibers of a fiber array unit, wherein the fibers may be arranged to correspond in position with grooves of an optical die; wherein the second segment may be configured to accommodate the adhesive displaced by the first segment, and wherein the first segment may be configured to prevent the adhesive from contacting a waveguide of the optical die, wherein the waveguide may be proximal to the grooves, and wherein the first segment and the second segment may be configurable to have the first segment displace the adhesive toward the second segment and away from the waveguide so as to couple the fiber array unit with the optical die. The operation 1106 of urging the apparatus against the adhesive dispensed on the fibers may include urging the first segment of the apparatus against the adhesive dispensed on the fibers to displace the adhesive toward the second segment and away from the waveguide. The method 1100 may further include lifting the apparatus described in various aspects and examples of the present disclosure away from the fibers after urging the first segment against the adhesive, and then urging the apparatus against the adhesive in a manner which renders the first segment and the second segment to contact the adhesive at a same time.

FIG. 10B is a flow diagram showing a method described in an aspect of the present disclosure. The method has been demonstrated in, for example, FIG. 9. FIG. 10B outlines a method 1200 for assisting with coupling a fiber array unit to an optical die. The method 1200 may involve an operation 1102 of arranging fibers of the fiber array unit to correspond in position with grooves of the optical die, an operation 1202 of dispensing an adhesive on an apparatus described in various aspects and examples of the present disclosure, an operation 1204 of configuring the apparatus to have the adhesive dispensed thereon face the fibers, an operation 1206 of contacting the adhesive dispensed on the apparatus with the fibers, and an operation 1208 of urging the apparatus against the adhesive to displace the adhesive toward the second segment and away from the waveguide so as to couple the fiber array unit with or to the optical die. The apparatus may include: a body, including a first segment and a second segment; wherein the first segment may be configured to urge an adhesive against fibers of a fiber array unit, wherein the fibers may be arranged to correspond in position with grooves of an optical die; wherein the second segment may be configured to accommodate the adhesive displaced by the first segment, and wherein the first segment may be configured to prevent the adhesive from contacting a waveguide of the optical die, wherein the waveguide may be proximal to the grooves, and wherein the first segment and the second segment may be configurable to have the first segment displace the adhesive toward the second segment and away from the waveguide so as to couple the fiber array unit with the optical die. The operation 1206 of contacting the adhesive dispensed on the apparatus with the fibers may include moving the apparatus toward to the fibers in a manner which renders the adhesive dispensed on the first segment and on the second segment to contact the fibers at the same time.

While not shown in any of the figures, it is readily understandable that there may be an apparatus (of the present disclosure) including a lid that may be coupled with or to the optical die (e.g., the lid may be adhered to the fibers). Such an apparatus may include an optical die, including a plurality of grooves; a plurality of optical fibers, arranged in the plurality of grooves; a lid, including a first surface and a second surface, opposite the first surface, wherein the second surface may be non-parallel to the first surface; and an adhesive layer between the optical die and the second surface of the lid. The lid may be the apparatus 100 denoted in, for example, any of FIG. 3, FIGS. 4A and 4B, FIG. 5 to FIG. 6 and FIG. 9 as well as the apparatus mentioned in FIG. 10A and FIG. 10B.

To more readily understand and put into practical effect the present apparatus and method, they will now be described by way of examples. For the sake of brevity, duplicate descriptions of features and properties may be omitted.

### Examples

Example 1 may include an apparatus that may include an optical die, including a plurality of grooves. The apparatus may include a plurality of optical fibers, arranged in the plurality of grooves. The apparatus may include a lid, including a first surface and a second surface, opposite the first surface, for which, the second surface may be non-parallel to the first surface. Also, the apparatus may include an adhesive layer between the optical die and the second surface of the lid. The lid may be described in any of examples 5 to 16 and/or any other example disclosed herein.

Example 2 may include the apparatus of example 1 and/or any other example disclosed herein, for which, the second surface of the lid may include or define a recess, configured to receive adhesive during an adhesion process.

Example 3 may include the apparatus of example 2 and/or any other example disclosed herein, for which, the recess may extend from a portion of the second surface through a portion of the first surface.

Example 4 may include the apparatus of example 1 and/or any other example disclosed herein, for which, the lid may include a first side, defining a first distance between the first surface and the second surface, and a second side, defining a second distance between the first surface and the second surface, for which, the first distance is greater than the second distance. The apparatus may further include one or more waveguides, adjacent to one or more of the grooves, for which, the lid may be positioned such that the first side may be closer to the one or more waveguides than the second side.

Example 5 may include an apparatus that may include a body, including a first segment and a second segment, for which, the first segment may be configured to urge an adhesive against fibers of a fiber array unit, for which, the fibers may be arranged to correspond in position with grooves of an optical die. In various aspects and examples, the apparatus described in example 5 may be a lid. The lid may be a lid mentioned in any of examples 1 to 4 and/or any other example disclosed herein. In various aspects and examples, the second segment, together with the first segment, may be formed as a body, for example, a single body. The term “single body” in the context of the present disclosure refers to multiple elements being formed as one physical entity or object, as opposed to multiple separate entities. In various aspects and examples, the second segment may be configured to accommodate the adhesive displaced by the first segment. In various aspects and examples, the first segment may be configured to prevent the adhesive from contacting a waveguide of the optical die. In various aspects and examples, the waveguide may be proximal to the grooves. In various aspects and examples, the first segment and the second segment may be configurable to have the first segment displace the adhesive toward the second segment and away from the waveguide so as to couple the fiber array unit with the optical die, in other words, the apparatus may be operated in a manner that renders the first segment to displace the adhesive toward the direction of the second segment and away from the waveguide. In various aspects and examples, the grooves may be V-shaped grooves. In various aspects and examples, the optical die may contain the waveguide and the grooves.

Example 6 may include the apparatus of example 5 and/or any other example disclosed herein, for which, the body may include a planar surface, and for which, the planar surface may include at least part of the first segment and at least part of the second segment. The planar surface may be configured for urging the adhesive against the fibers.

Example 7 may include the apparatus of example 5 and/or any other example disclosed herein, for which, the first segment and/or the second segment each may include an edge contactable with the fibers to prevent the adhesive from contacting the waveguide, for which, the edge may be a vertex defined by a planar surface and a surface extending vertically from the planar surface. In various aspects and examples, the planar surface and the vertical surface may be orthogonal to each other, defining a 90° edge.

Example 8 may include the apparatus of example 7 and/or any other example disclosed herein, for which, the planar surface may be an inclined planar surface connecting the first segment and the second segment.

Example 9 may include the apparatus of example 8 and/or any other example disclosed herein, for which, the second segment may include an opening for the adhesive to be dispensed through the apparatus onto the fibers.

Example 10 may include the apparatus of example 5 and/or any other example disclosed herein, for which, the first segment may include a planar surface and the second segment may be shorter in height compared to the first segment so as to render an inclined planar surface at the second segment, for which, the planar surface may be configurable to be parallel to the waveguide, and for which, the inclined planar surface may connect to the planar surface of the first segment. In various aspects and examples, the inclined planar surface may accommodate adhesive displaced by the first segment.

Example 11 may include the apparatus of example 5 and/or any other example disclosed herein, for which, the second segment may include an opening for the adhesive to be dispensed through the apparatus onto the fibers. The opening may also accommodate for any adhesive displaced by the first segment.

Example 12 may include the apparatus of example 5 and/or any other example disclosed herein, for which, a portion of the second segment proximal to the first segment may include a channel to accommodate the adhesive displaced by the first segment.

Example 13 may include the apparatus of example 12 and/or any other example disclosed herein, for which, the channel may be configured orthogonally to the grooves and may extend across the apparatus to render an opening at one vertical side of the apparatus and another opening at an opposing vertical side of the apparatus.

Example 14 may include the apparatus of example 10 and/or any other example disclosed herein, for which, the second segment may include an opening for the adhesive to be dispensed through the apparatus onto the fibers.

Example 15 may include the apparatus of example 10 and/or any other example disclosed herein, for which, a portion of the second segment proximal to the first segment may include a channel to accommodate the adhesive displaced by the first segment.

Example 16 may include the apparatus of example 15 and/or any other example disclosed herein, for which, the channel may be configured orthogonally to the grooves and may extend across the apparatus to render an opening at one vertical side of the apparatus and another opening at an opposing vertical side of the apparatus.

Example 17 may include a method that includes arranging fibers of a fiber array unit to correspond in position with grooves of an optical die, dispensing an adhesive on the fibers, and urging an apparatus against the adhesive dispensed on the fibers to displace the adhesive toward the second segment and away from the waveguide so as to couple the fiber array unit with or to the optical die. The apparatus may be an apparatus described in any of examples 5 to 16. The apparatus may include a body, including a first segment and a second segment, for which, the first segment may be configured to urge an adhesive against fibers of a fiber array unit, for which, the fibers may be arranged to correspond in position with grooves of an optical die. In various aspects and examples, the second segment, together with the first segment, may be formed as a body, for example, a single body. The term “single body” in the context of the present disclosure refers to multiple elements being formed as one physical entity or object, as opposed to multiple separate entities. In various aspects and examples, the second segment may be configured to accommodate the adhesive displaced by the first segment. In various aspects and examples, the first segment may be configured to prevent the adhesive from contacting a waveguide of the optical die. In various aspects and examples, the waveguide may be proximal to the grooves. In various aspects and examples, the first segment and the second segment may be configurable to have the first segment displace the adhesive toward the second segment and away from the waveguide so as to couple the fiber array unit with the optical die, in other words, the apparatus may be operated in a manner that renders the first segment to displace the adhesive toward the direction of the second segment and away from the waveguide. In various aspects and examples, the grooves may be V-shaped grooves. In various aspects and examples, the optical die may contain the waveguide and the grooves. In various aspects and examples, the apparatus described in example 17 may be a lid. The lid may be a lid mentioned in any of examples 1 to 4 and/or any other example disclosed herein.

Example 18 may include the method of example 17 and/or any other example disclosed herein, for which, urging the apparatus of any of examples 5 to 16 against the adhesive dispensed on the fibers may include urging the first segment of the apparatus of any of examples 5 to 16 against the adhesive dispensed on the fibers to displace the adhesive toward the second segment and away from the waveguide.

Example 19 may include the method of example 18 and/or any other example disclosed herein, for which, the method may further include lifting the apparatus of any of examples 5 to 16 away from the fibers after urging the first segment against the adhesive, and urging the apparatus of any of examples 5 to 16 against the adhesive in a manner which renders the first segment and the second segment to contact the adhesive at the same time.

Example 20 may include the method of example 17 and/or any other example disclosed herein, for which, the adhesive may include an epoxy-based polymer composite curable by ultraviolet light, an acrylic-based polymer composite curable by ultraviolet light, a polyurethane-based polymer composite curable by ultraviolet light, and/or a polyimide-based polymer composite curable by ultraviolet light.

Example 21 may include a method that includes arranging fibers of a fiber array unit to correspond in position with grooves of an optical die, dispensing an adhesive on the apparatus of any of examples 5 to 16, configuring the apparatus of any of examples 5 to 16 to have the adhesive dispensed thereon face the fibers, contacting the adhesive dispensed on the apparatus of any of examples 5 to 16 with the fibers, and urging the apparatus of any of examples 5 to 16 against the adhesive to displace the adhesive toward the second segment and away from the waveguide so as to couple the fiber array unit with or to the optical die.

Example 22 may include the method of example 21 and/or any other example disclosed herein, for which, contacting the adhesive dispensed on the apparatus of any of examples 5 to 16 with the fibers may include moving the apparatus of any of examples 5 to 16 toward to the fibers in a manner which renders the adhesive dispensed on the first segment and on the second segment to contact the fibers at the same time.

Example 23 may include the method of example 21 and/or any other example disclosed herein, for which, the adhesive may include an epoxy-based polymer composite curable by ultraviolet light, an acrylic-based polymer composite curable by ultraviolet light, a polyurethane-based polymer composite curable by ultraviolet light, and/or a polyimide-based polymer composite curable by ultraviolet light.

The term “comprising” shall be understood to have a broad meaning similar to the term “including” and will be understood to imply the inclusion of a stated integer or operation or group of integers or operations but not the exclusion of any other integer or operation or group of integers or operations. This definition also applies to variations on the term “comprising” such as “comprise” and “comprises”.

While the present disclosure has been particularly shown and described with reference to specific aspects, it should be understood by persons skilled in the art that various changes in form and detail may be made therein without departing from the scope of the present disclosure as defined by the appended claims. The scope of the present disclosure is thus indicated by the appended claims and all changes which come within the meaning and range of equivalency of the claims are therefore intended to be embraced.

What is claimed is:

1. An apparatus comprising:
an optical die, comprising a plurality of grooves;
a plurality of optical fibers, arranged in the plurality of grooves;
a lid, comprising a first surface and a second surface, opposite the first surface, wherein the second surface is non-parallel to the first surface; and
an adhesive layer between the optical die and the second surface of the lid.

2. The apparatus of claim 1, wherein the second surface of the lid comprises a recess, configured to receive adhesive during an adhesion process.

3. The apparatus of claim 2, wherein the recess extends from a portion of the second surface through a portion of the first surface.

4. The apparatus of claim 1, wherein the lid comprises a first side, defining a first distance between the first surface and the second surface, and a second side, defining a second distance between the first surface and the second surface, wherein the first distance is greater than the second distance, further comprising one or more waveguides, adjacent to one or more of the grooves, wherein the lid is positioned such that the first side is closer to the one or more waveguides than the second side.

5. An apparatus comprising:
a body, comprising a first segment and a second segment;
wherein the first segment is configured to urge an adhesive against fibers of a fiber array unit, wherein the fibers are arranged to correspond in position with grooves of an optical die;
wherein the second segment is configured to accommodate the adhesive displaced by the first segment, and
wherein the first segment is configured to prevent the adhesive from contacting a waveguide of the optical die, wherein the waveguide is proximal to the grooves, and wherein the first segment and the second segment are configurable to have the first segment displace the adhesive toward the second segment and away from the waveguide so as to couple the fiber array unit with the optical die.

6. The apparatus of claim 5, wherein the body comprises a planar surface, and wherein the planar surface comprises at least part of the first segment and at least part of the second segment.

7. The apparatus of claim 5, wherein the first segment and/or the second segment each comprise an edge contactable with the fibers to prevent the adhesive from contacting the waveguide, wherein the edge is a vertex defined by a planar surface and a surface extending vertically from the planar surface.

8. The apparatus of claim 7, wherein the planar surface is an inclined planar surface connecting the first segment and the second segment.

9. The apparatus of claim 8, wherein the second segment comprises an opening for the adhesive to be dispensed through the apparatus onto the fibers.

10. The apparatus of claim 5, wherein the first segment comprises a planar surface and the second segment is shorter in height compared to the first segment so as to render an inclined planar surface at the second segment, wherein the planar surface is configurable to be parallel to the waveguide, and wherein the inclined planar surface connects to the planar surface of the first segment.

11. The apparatus of claim 5, wherein the second segment comprises an opening for the adhesive to be dispensed through the apparatus onto the fibers.

12. The apparatus of claim 5, wherein a portion of the second segment proximal to the first segment comprises a channel to accommodate the adhesive displaced by the first segment.

13. The apparatus of claim 12, wherein the channel is configured orthogonally to the grooves and extends across the apparatus to render an opening at one vertical side of the apparatus and another opening at an opposing vertical side of the apparatus.

14. The apparatus of claim 10, wherein the second segment comprises an opening for the adhesive to be dispensed through the apparatus onto the fibers.

15. The apparatus of claim 10, wherein a portion of the second segment proximal to the first segment comprises a channel to accommodate the adhesive displaced by the first segment.

16. The apparatus of claim 15, wherein the channel is configured orthogonally to the grooves and extends across the apparatus to render an opening at one vertical side of the apparatus and another opening at an opposing vertical side of the apparatus.

17. A method comprising:
arranging fibers of a fiber array unit to correspond in position with grooves of an optical die;
dispensing an adhesive on the fibers; and
urging an apparatus against the adhesive dispensed on the fibers to displace the adhesive toward a second segment and away from a waveguide so as to couple the fiber array unit with the optical die, wherein the apparatus comprises: a body, comprising a first segment and a second segment, wherein the first segment is configured to urge an adhesive against fibers of a fiber array unit, wherein the fibers are arranged to correspond in position with grooves of an optical die, wherein the second segment is configured to accommodate the adhesive displaced by the first segment, and wherein the first segment is configured to prevent the adhesive from contacting a waveguide of the optical die, the waveguide being proximal to the grooves, and wherein the first segment and the second segment are configurable to have the first segment displace the adhesive toward the second segment and away from the waveguide so as to couple the fiber array unit with the optical die.

18. The method of claim 17, wherein urging the apparatus against the adhesive dispensed on the fibers comprises urging the first segment of the apparatus against the adhesive dispensed on the fibers to displace the adhesive toward the second segment and away from the waveguide.

19. The method of claim 18, further comprising:
lifting the apparatus away from the fibers after urging the first segment against the adhesive; and
urging the apparatus against the adhesive in a manner which renders the first segment and the second segment to contact the adhesive at a same time.

20. The method of claim 17, wherein the adhesive comprises an epoxy-based polymer composite curable by ultraviolet light, an acrylic-based polymer composite curable by ultraviolet light, a polyurethane-based polymer composite curable by ultraviolet light, or a polyimide-based polymer composite curable by ultraviolet light.
